(19) United States
(12) Patent Application Publication
(10) Pub. No.: US 2019/0161012 A1
(43) Pub. Date: May 30, 2019

(54) APPARATUS AND METHOD FOR CONTROLLING DISPLAY IN VEHICLE

(71) Applicants: Hyundai Motor Company, Seoul (KR); Kia Motors Corporation, Seoul (KR); SL Mirrortech Corporation, Siheung (KR)

(72) Inventors: Hyun Sub Kim, Seoul (KR); Seok Keon Kwon, Anyang (KR); Jung Yeol Ye, Seoul (KR); Chang Ju Kim, Daegu (KR)

(21) Appl. No.: 15/953,754

(22) Filed: Apr. 16, 2018

(30) Foreign Application Priority Data
Nov. 30, 2017 (KR) 10-2017-0163382

(51) Int. Cl. B60R 1/00; H04N 7/18; H04N 5/262; G06F 3/14; H04N 5/272; B60R 11/04

(52) U.S. Cl. CPC B60R 1/002; H04N 7/181; H04N 5/2628; B60R 2011/004; H04N 5/272; B60R 11/04; G06F 3/1423

(57) ABSTRACT

An apparatus for controlling a display in a vehicle includes: a first camera mounted on a region of a door of the vehicle and configured to capture a first image of a side zone and a rear side zone of the vehicle; a second camera mounted on a region of a rear end of the vehicle and configured to capture a second image of a rear zone and the rear side zone of the vehicle; an image generator configured to generate a third image using the second image; and an output controller configured to display the first image on a display screen when the vehicle is driven and to display the third image on the display screen when the door of the vehicle is opened.

### CROSS-REFERENCE TO RELATED APPLICATION

This application claims the benefit of priority to Korean Patent Application No. 10-2017-0163382, filed on Nov. 30, 2017 in the Korean Intellectual Property Office, the disclosure of which is incorporated herein in its entirety by reference.

### TECHNICAL FIELD

The present disclosure relates to vehicular technologies and, more particularly, to apparatuses and methods for controlling a display in a vehicle.

### BACKGROUND

An outside-view monitoring system of a vehicle may display images on a display screen captured by cameras mounted at positions around the vehicle, allowing a driver to obtain views of sides and the rear of the vehicle during driving. In some cases, the outside-view monitoring system may use images of cameras installed in driver-side and passenger-side doors of the vehicle. As such, when one of the driver- or passenger-side doors is opened, an image capture angle of the camera may be changed. Similarly, a view of the camera may be obstructed when a rear door of the vehicle is opened.

Thus, in a conventional outside-view monitoring system, an image capture angle may be changed in a state where a vehicle door of a vehicle is opened, causing distortion of the displayed image, or a blank screen may be displayed rather than an image captured by camera.

### SUMMARY

The present disclosure has been made to solve the above-mentioned problems occurring in the related art while advantages achieved by the related art are maintained intact.

An aspect of the present disclosure provides an apparatus and method for controlling a display in a vehicle to obtain views of a rear and a rear side of the vehicle through a display screen by generating and displaying a third image based on images of a rear zone and a rear side zone of a rear view camera, a peripheral monitoring camera, or an inside-view monitoring camera when detecting a door-open state of a vehicle.

The technical problems to be solved by the present inventive concept are not limited to the aforementioned problems, and any other technical problems not mentioned herein will be clearly understood from the following description by those skilled in the art to which the present disclosure pertains.

According to embodiments of the present disclosure, an apparatus for controlling a display in a vehicle may include: a first camera mounted on a region of a door of the vehicle and configured to capture a first image of a side zone and a rear side zone of the vehicle; a second camera mounted on a region of a rear end of the vehicle and configured to capture a second image of a rear zone and the rear side zone of the vehicle; an image generator configured to generate a third image using the second image; and an output controller configured to display the first image on a display screen when the vehicle is driven and to display the third image on the display screen when the door of the vehicle is opened.

The image generator may be further configured to: determine a partial region of the second image as a crop region; extract a crop image with respect to the crop region; and generate the third image using the extracted crop image.

The image generator may be further configured to: calculate a horizontal angle of view of the crop region based on a horizontal angle of view of the first camera and a horizontal angle of view of the second camera; and calculate a vertical angle of view of the crop region based on a vertical angle of view of the first camera, a vertical angle of view of the second camera, the calculated horizontal angle of view of the crop region, and a resolution of the display screen.

The image generator may be further configured to generate the third image by adding a door-open warning image to the crop image.

The image generator may be further configured to generate the third image by synthesizing the first image with respect to the second image.

The image generator may be further configured to: determine a partial region of the first image as a first crop region and determine a partial region of the second image as a second crop region, extract a first crop image with respect to the first crop region, and extract a second crop image with respect to the second crop region.

The image generator may be further configured to: calculate a horizontal angle of view of the first crop region based on a horizontal angle of view of the first camera; and calculate a vertical angle of view of the first crop region based on a vertical angle of view of the first camera, a vertical angle of view of the second camera, the calculated horizontal angle of view of the first crop region, and a resolution of the display screen.

The image generator may be further configured to: calculate a horizontal angle of view of the second crop region based on a horizontal angle of view of the second camera; and calculate a vertical angle of view of the second crop region based on a vertical angle of view of the first camera, a vertical angle of view of the second camera, the calculated horizontal angle of view of the second crop region, and a resolution of the display screen.

The image generator may be further configured to determine the first crop region and the second crop region based on which of a vertical angle of view of the first crop region and a vertical angle of view of the second crop region is a narrower angle of view, when the vertical angle of view of the first crop region and the vertical angle of view of the second crop region differ from each other.

The image generator may be further configured to generate a synthesis image by synthesizing the first crop image with respect to the second crop image and generate the third image based on the generated synthesis image.

The image generator may be further configured to generate the third image by adding a door-open warning image to the synthesis image.

The second camera may include one or more of: a rear view camera, a camera of a peripheral monitoring system, and a camera of an inside-view monitoring system.

The second camera may include a plurality of different cameras.

The output controller may be further configured to: generate a third image selection screen including a plurality of images obtained from the plurality of different cameras when the door is opened; and display the third image selection screen on the display screen.

The third image selection screen may include a door-open warning image on a region of the third image selection screen.

The image generator may be further configured to, when one of the plurality of images displayed on the third image selection screen is selected, generate the third image based on the selected image.

The second camera may include at least two or more of: a rear view camera, a camera of a peripheral monitoring system, and a camera of an inside-view monitoring system.

Furthermore, according to embodiments of the present disclosure, a method for controlling a display in a vehicle may include: capturing a first image of a side zone and a rear side zone of the vehicle using a first camera mounted on a region of a door of the vehicle; capturing a second image of a rear zone and the rear side zone of the vehicle using a second camera mounted on a region of a rear end of the vehicle; generating a third image using the second image; displaying the first image on a display screen when the vehicle is driven; and displaying the third image on the display screen when the door of the vehicle is opened.

The generating of the third image may include: determining a partial region of the second image as a crop region; extracting a crop image with respect to the crop region; and generating the third image using the extracted crop image.

The generating of the third image may include: determining a partial region of the first image as a first crop region; extracting a first crop image with respect to the first crop region; determining a partial region of the second image as a second crop region; extracting a second crop image with respect to the second crop region; generating a synthesis image by synthesizing the first crop image with respect to the second crop image; and generating the third image based on the generated synthesis image.

The method may further include: generating a third image selection screen including a plurality of images obtained from a plurality of different cameras configured to capture a rear zone and the rear side zone of the vehicle when the door is opened; and displaying the third image selection screen on the display screen.

The generating of the third image may include generating the third image based on a selected image when one of the plurality of images displayed on the third image selection screen is selected.

### BRIEF DESCRIPTION OF THE DRAWINGS

The above and other objects, features and advantages of the present disclosure will be more apparent from the following detailed description taken in conjunction with the accompanying drawings:

FIG. 1 is a drawing illustrating a vehicle to which an apparatus for controlling a display in a vehicle is applied, according to embodiments of the present disclosure;

FIG. 2 is a block diagram illustrating a configuration of an apparatus for controlling a display in a vehicle according to embodiments of the present disclosure;

FIGS. 3A and 3B are drawings illustrating cameras applied to an apparatus for controlling a display in a vehicle according to embodiments of the present disclosure;

FIGS. 4A, 4B, and 4C are drawings illustrating an operation of an apparatus for controlling a display in a vehicle according to embodiments of the present disclosure;

FIGS. 5A and 5B are drawings illustrating additional operation of the apparatus for controlling a display in a vehicle according to embodiments of the present disclosure;

FIG. 6 is a drawing illustrating additional operation of the apparatus for controlling a display in a vehicle according to embodiments of the present disclosure;

FIGS. 7, 8, and 9 are flowcharts illustrating an operation of a method for controlling a display in a vehicle according to embodiments of the present disclosure; and

FIG. 10 is a block diagram illustrating a configuration of a computing system in which a method according to embodiments of the present disclosure is executed.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Hereinafter, embodiments of the present disclosure will be described in detail with reference to the accompanying drawings. In adding reference denotations to elements of each drawing, although the same elements are displayed on a different drawing, it should be noted that the same elements have the same denotations. In addition, in describing an embodiment of the present disclosure, if it is determined that a detailed description of related well-known configurations or functions blurs the gist of an embodiment of the present disclosure, it will be omitted.

In describing elements of embodiments of the present disclosure, the terms 1^{st}, 2^{nd}, first, second, A, B, (a), (b), and the like may be used herein. These terms are only used to distinguish one element from another element, but do not limit the corresponding elements irrespective of the nature, turn, or order of the corresponding elements. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one control unit and/or controller. The term “control unit” and “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the control unit and/or controller in conjunction with one or more other components, as would be appreciated by a person of ordinary skill in the art.

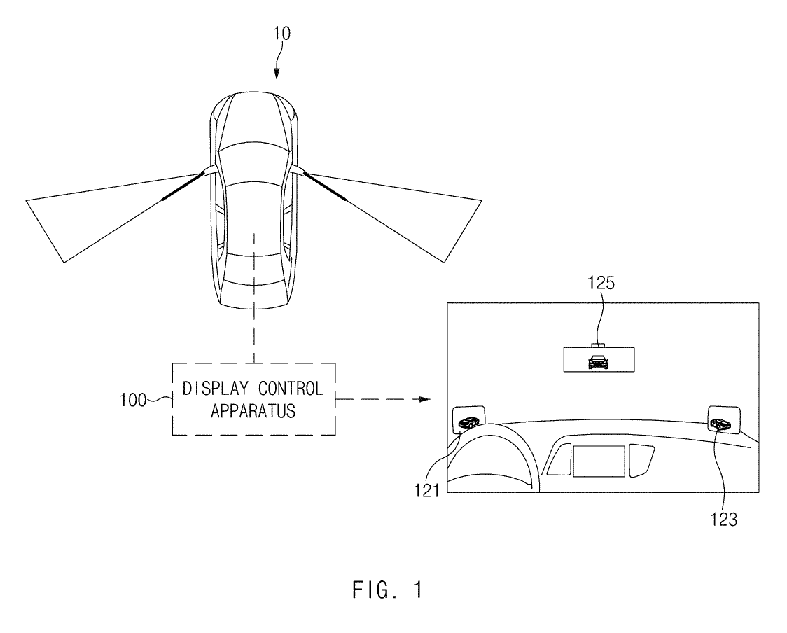

Referring now to the presently disclosed embodiments, FIG. 1 is a drawing illustrating a vehicle to which an apparatus for controlling a display in a vehicle is applied, according to embodiments of the present disclosure.

As shown in FIG. 1, if a door-open state of a vehicle 10 is detected while displaying on screens of displays 121 to 125 in the vehicle 10 an image (hereinafter referred to as “first image”) of a first camera, which is mounted on a region of a door of the vehicle 10 and is configured to capture a left zone, a right zone, and a rear side zone of the vehicle 10, an apparatus 100 (hereinafter referred to as “display control apparatus 100”) for controlling a display in a vehicle 10 may generate a “third image” using an image (hereinafter referred to as “second image”) obtained from at least one second camera (not shown) which captures a rear of the vehicle 10. The display control apparatus 100 may display the third image on the screens of the displays 121 to 125 in the vehicle 10 while the door-open state is detected, such that views of a side and a rear of the vehicle 10 are provided to the driver.

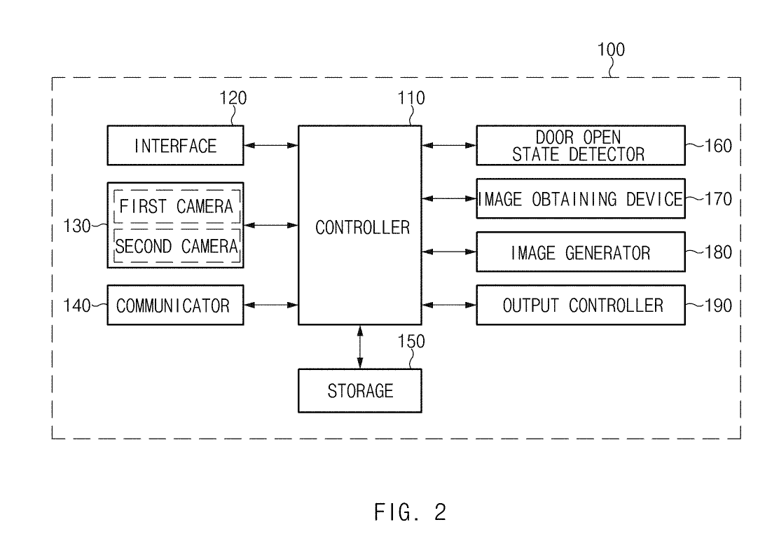

A description will be given in detail of a detailed configuration of the display control apparatus 100 with reference to FIG. 2.

The display control apparatus 100 may be implemented in the vehicle 10. For example, the display control apparatus 100 may be integrated with internal control units of the vehicle 10. Alternatively, the display control apparatus 100 may be implemented to be independent of the internal control units of the vehicle 10 and may be connected with the control units of the vehicle 10 by a separate connection means.

FIG. 2 is a block diagram illustrating a configuration of an apparatus for controlling a display in a vehicle according to embodiments of the present disclosure.

As shown in FIG. 2, a display control apparatus 100 may include a controller 110, an interface 120, a camera unit 130, a communicator 140, a storage 150, a door-open state detector 160, an image obtaining device 170, an image generator 180, and an output controller 190. Herein, the controller 110, the door-open state detector 160, the image obtaining device 170, the image generator 180, and the output controller 190 of the display control apparatus 100 according to embodiments of the present disclosure may be implemented by at least one or more processors.

The controller 100 may process a signal transmitted between the elements of the display control apparatus 100.

The interface 120 may include an input means for receiving a control instruction from a user and an output means for outputting an operation state, an operation result, and the like of the display control apparatus 100.

Herein, the input means may include a key button and may further include a mouse, a joystick, a jog shuttle, a stylus pen, and the like. Also, the input means may include a soft key implemented on a display of a vehicle 10 of FIG. 1.

The output means may include the display and may further include a voice output means such as a speaker. In this case, if a touch sensor such as a touch film, a touch sheet, or a touch pad is installed in the display, the display may operate as a touch screen and may be implemented in the form of integrating the input means with the output means.

In this case, the display may include at least one of a liquid crystal display (LCD), a thin film transistor-LCD (TFT-LCD), an organic light-emitting diode (OLED), a flexible display, a field emission display (FED), and a three-dimensional (3D) display.

For example, the display may include displays 121 and 123 of an outside-view monitoring system installed around left and right mirrors in the vehicle 10. Further, the display may include a display 125 of an inside-view monitoring system located in a room mirror in the vehicle 10. Further, the display may include a display of a navigation system (not shown) in the vehicle 10.

Herein, the display may display an image of the outside-view monitoring system, the inside-view monitoring system, and/or a peripheral monitoring system. Further, the display may display a third image generated by the image generator 180.

The outside-view monitoring system may refer to a system which includes cameras which are located on doors of the vehicle 10, for example, a left door and a right door of the vehicle 10 to capture images of a left zone, a right zone, and a rear side zone of the vehicle 10 and a display which is located in the vehicle 10 around left and right mirrors to display the images of the left zone, the right zone, and the rear side zone, captured by the cameras, such that a driver obtains views of the left zone, the right zone, and the rear side zone of the vehicle 10 through the display in the vehicle 10 while the vehicle 10 is driven.

The inside-view monitoring system may refer to a system which includes a camera which is located on an upper portion of a rear end of the vehicle 10 to capture images of a rear zone and a partial rear side zone of the vehicle 10 and a display which is located on a room mirror in the vehicle 10 to display the image captured by the camera, such that the driver obtains views of the rear zone and the partial rear side zone of the vehicle 10 through the room mirror if a specific operation condition is met.

The peripheral monitoring system may include an around view monitoring system, a surround view monitoring system, or the like. The peripheral monitoring system may refer to a system which includes cameras which are respectively located on a front end, a rear end, a left door, and a right door of the vehicle 10 and a display which displays an image in the form of synthesizing view conversion images of images of the cameras, such that the driver obtains a view around the vehicle 10 through the image displayed on the display if a specific operation condition is met.

The camera unit 130 may be a device for capturing an image around the vehicle 10 and, for example, may be installed on each of a front end, a rear end, a left portion, and/or a right portion of the vehicle 10. Herein, the camera unit 130 may include a wide-angle camera.

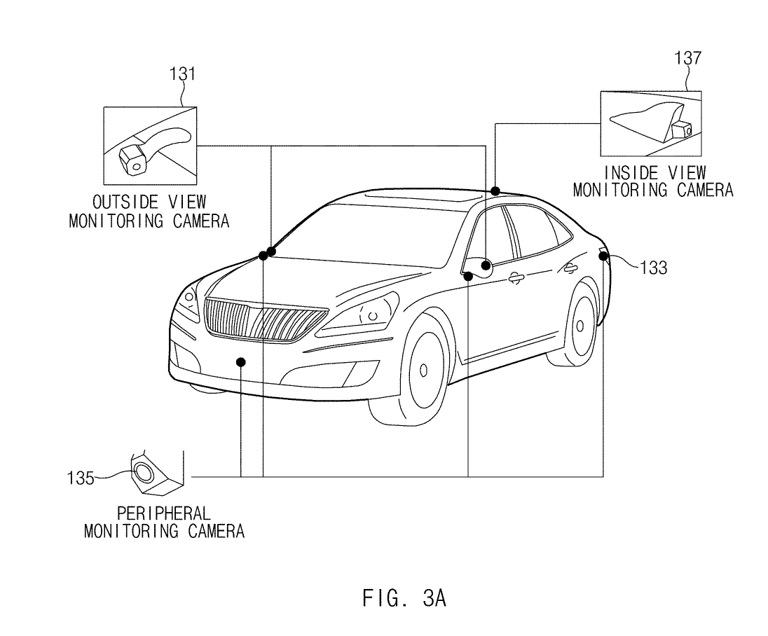

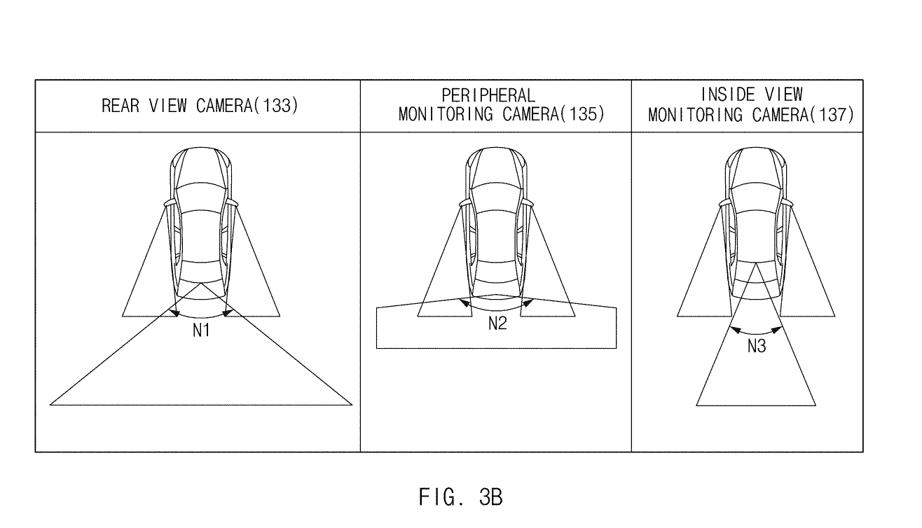

The camera unit 130 may include a first camera for capturing a left zone, a right zone, and a rear side zone of the vehicle 10. For example, the first camera may be a camera 131 of an outside-view monitoring system (hereinafter referred to as “outside-view monitoring camera 131”) shown in FIG. 3A. As shown in FIG. 3A, the first camera may be installed on left and right doors of the vehicle 10.

Further, the camera unit 130 may include a second camera for capturing a rear zone and/or a rear side zone of the vehicle 10. Herein, the second camera may be one camera or a plurality of different cameras.

For example, as shown in FIG. 3A, the second camera may include a rear view camera 133 mounted on a rear end of the vehicle 10. For another example, as shown in FIG. 3A, the second camera may include at least one or more of the rear view camera 133, cameras 135 of a peripheral monitoring system (hereinafter referred to as “peripheral monitoring camera 135”), mounted on a front end, a rear end, a left door, and a right door of the vehicle 10, and a camera 137 of an inside-view monitoring system (hereinafter referred to as “inside-view monitoring camera 137”), mounted on an upper portion of a rear end of the vehicle 10. Herein, the peripheral monitoring camera 135 may include only a rear view camera of the peripheral monitoring system.

Further, as shown in FIGS. 3A and 3B, the outside-view monitoring system, the peripheral monitoring system, and the inside-view monitoring system are described. However, a name of each system indicates an embodiment and is not limited thereto. It is apparent that a name of each system is described as another name according to an embodiment.

Herein, as shown in FIG. 3B, the rear view camera 133 may capture a short range and a mid-range image of a rear and a rear side of the vehicle 10 and may have a horizontal angle of view of N1. As an example, N1 may be an angle of 140 degrees.

As shown in FIG. 3B, the peripheral monitoring camera 135 may capture a short range image of a rear and a rear side of the vehicle 10 and may have a horizontal angle of view of N2 which is greater than N1 which is the horizontal angle of view of the rear view camera 133. As an example, N2 may be an angle of 180 degrees.

Further, as shown in FIG. 3B, the inside-view monitoring camera 137 may capture a mid-range image and a long range image of a rear and a partial rear side and may have a horizontal angle of view of N3 which is less than N1 which is the horizontal angle of view of the rear view camera 133. As an example, N3 may be an angle of 40 degrees.

The first camera and the at least one or more second cameras may transmit images captured by them to the controller 110. In this case, the controller 110 may store a first image and a second image transmitted from the first camera and the second camera in the storage 150 and may provide the first image and the second image to the image obtaining device 170 and/or the image generator 180.

The communicator 140 may include a communication module for supporting a communication interface with electronics and/or control units mounted on the vehicle 10. For example, the communication module may be communicatively connected with the outside-view monitoring system, the inside-view monitoring system, and/or the peripheral monitoring system mounted on the vehicle 10 and may receive an image of a camera controlled by each of the outside-view monitoring system, the inside-view monitoring system, and the peripheral monitoring system. Further, the communication module may transmit a third image generated by the image generator 180 to a display of each of the outside-view monitoring system, the inside-view monitoring system, and the peripheral monitoring system.

Further, the communication module may be communicatively connected with a sensor which senses a door-open state of the vehicle 10 and may receive a door-open signal.

Herein, the communication module may include a module for supporting vehicle network communication such as controller area network (CAN) communication, local interconnect network (LIN) communication, and flex-ray communication.

Further, the communication module may include a module for wireless Internet access or a module for short range communication. Herein, wireless Internet technologies may include a wireless local area network (WLAN), wireless broadband (Wibro), wireless-fidelity (Wi-Fi), world interoperability for microwave access (Wimax), and the like. Short range communication technologies may include Bluetooth, ZigBee, ultra wideband (UWB), radio frequency identification (RFID), infrared data association (IrDA), and the like.

The storage 150 may store data, an algorithm, and/or the like necessary for operating the display control apparatus 100.

For example, the storage 150 may store the first image and the second image captured by the first camera and/or the at least one or more second cameras. Further, the storage 150 may store the third image generated by the image generator 180. Further, the storage 150 may store condition information, an instruction, and/or an algorithm for determining a crop region from the at least one or more second images and generating a third image based on a crop image extracted relative to the crop region.

Herein, the storage 150 may include storage media such as a random access memory (RAM), a static RAM (SRAM), a read-only memory (ROM), a programmable ROM (PROM), and an electrically erasable PROM (EEPROM).

The output controller 190 may display the first image on a display screen. Herein, the first image may be an image captured by a left camera or may be an image captured by a right camera. Further, the first image may include all of images captured by the left camera and the right camera.

While the first image is displayed on the display screen, the door-open state detector 160 may detect a door-open state of the vehicle 10. Herein, the door-open state detector 160 may detect the door-open state of the vehicle 10 based on a door-open signal received from a sensor installed in the vehicle 10.

If the door-open state of the vehicle 10 is detected, the door-open state detector 160 may transmit information about the door-open state to the image obtaining device 170 and/or the controller 110.

The image obtaining device 170 may determine door-open state information from the door-open state detector 160 or the controller 110. When a door is opened, the image obtaining device 170 may control the at least one or more second cameras to be turned on.

In this case, the image obtaining device 170 may control one of the at least one or more second cameras to be turned on. As an example, when a door is opened, the image obtaining device 170 may control the rear view image 133 to be turned on. In this case, the image obtaining device 170 may transmit the second image, obtained from the second camera, to the image generator 180.

Meanwhile, when a door is opened, the image obtaining device 170 may control all of the plurality of second cameras to be turned on. As an example, the image obtaining device 170 may control the rear view camera 133, the peripheral monitoring camera 135, and the inside-view monitoring camera 137 to be turned on. In this case, the image obtaining device 170 may transmit the second image, obtained from the plurality of second cameras, to the output controller 190.

Meanwhile, when a door is opened, the image obtaining device 170 may obtain the first image and the at least one or more second images and may transmit the first image and the at least one or more second images to the image generator 180.

The image generator 180 may determine a partial region of the second image obtained by the image obtaining device 170 as a crop region and may extract a crop image with respect to the determined crop region. In this case, the image generator 180 may generate a third image based on the crop image.

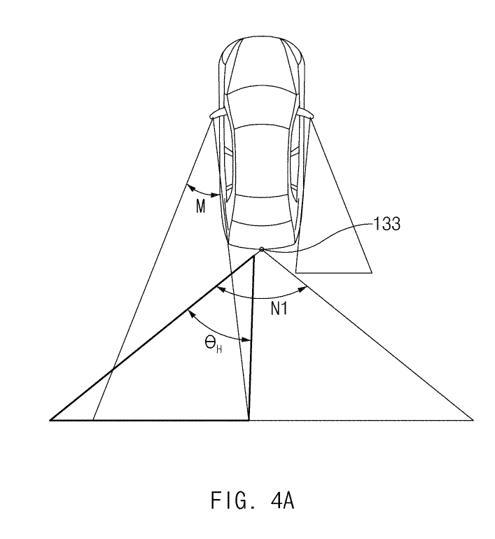

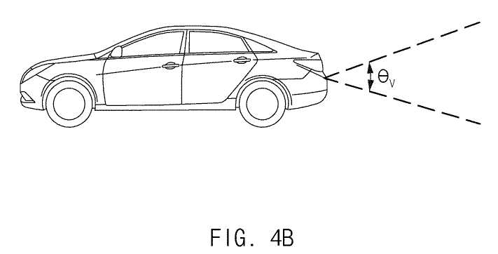

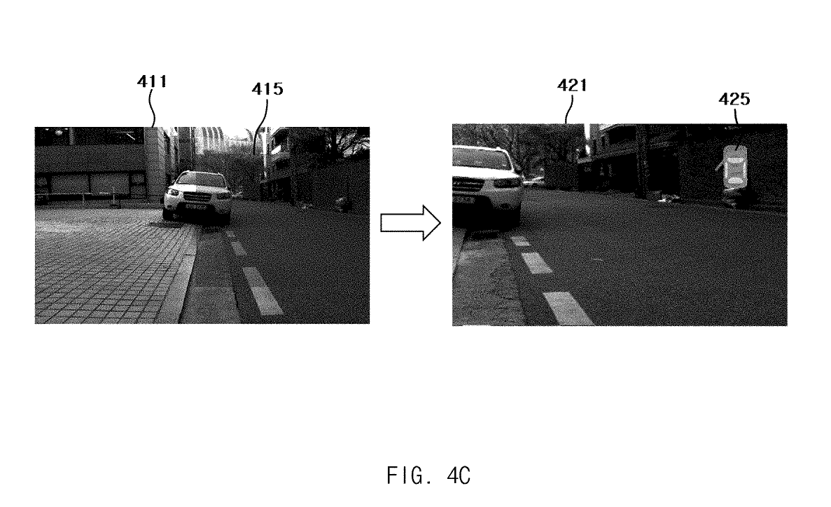

Herein, the image generator 180 may determine a horizontal angle of view of the crop region based on a horizontal angle of view of the first camera and a horizontal angle of view of the second camera. Further, the image generator 180 may determine a vertical angle of view of the crop region based on a vertical angle of view of the first camera, a vertical angle of view of the second camera, the determined horizontal angle of view of the crop region, and resolution of a display. A description will be given of examples of determining the crop region for an image of the second camera and generating the third image based on the determined crop region with reference to FIGS. 4A to 4C.

FIGS. 4A to 4C are drawings illustrating an operation of an apparatus for controlling a display in a vehicle according to embodiments of the present disclosure. Here, a first camera is an outside-view monitoring camera 131 of FIG. 3A and as a second camera is a rear view camera 133.

First of all, FIG. 4A illustrates an embodiment of determining a horizontal angle of view of a crop region for an image of the second image.

As shown in FIG. 4A, when a horizontal angle of view of the first camera is M and when a horizontal angle of view of the second camera is N1, an image generator 180 of FIG. 2 may calculate a horizontal angle θ_{H} of view of a crop region in a range of M<Θ_{H}<N1/2. For example, if M is an angle of 30 degrees and if N is an angle of 140 degrees, the image generator 180 may calculate the horizontal angle θ_{H} of view of the crop region in a range of 30 degrees<Θ_{H}<70 degrees. In this case, the horizontal angle θ_{H} of view of the crop region may be randomly determined in the range of M<Θ_{H}<N1/2.

FIG. 4B illustrates an embodiment of determining a vertical angle of view of a crop region for an image of the second camera.

As shown in FIG. 4B, when a vertical angle of view of the first camera is P and when a horizontal angle of view of the second camera is V1, the image generator 180 may determine a vertical angle θ_{V} of view of a crop region in a range of P<Θ_{V}<V1.

In this case, the image generator 180 may determine the vertical angle θ_{V} of view for the horizontal angle θ_{H} of view of the crop region determined by the embodiment of FIG. 4A, with respect to the ratio X:Y of horizontal resolution to vertical resolution of a display. Herein, if resolution of the display is X:Y, the image generator 180 may determine the vertical angle θ_{V} of view of the crop region based on “X:Y=Θ_{H}:θ_{V}”. In this case, the image generator 180 may determine a value which meets “X:Y=Θ_{H}:θ_{V}” in the range of P<Θ_{V}<V1 as the vertical angle θ_{V} of view of the crop region.

As an example, if the vertical angle of view of the first camera is 30 degrees, if the vertical angle of view of the second camera is 70 degrees, if the resolution X:Y of the display is 16:9, and if the horizontal angle θ_{H} of view of the crop region is 64 degrees, the image generator 180 may determine the vertical angle θ_{V} of view as 36 degrees from “16:9=64:θ_{V}”. In this case, the determined vertical angle θ_{V} of view may meet a range of 30 degrees<Θ_{V}<70 degrees.

As such, the image generator 180 may determine a crop region for a second image based on the horizontal angle θ_{H} of view determined by the embodiment of FIG. 4A and the vertical angle Θ_{V} of view determined by the embodiment of FIG. 4B.

FIG. 4C illustrates an embodiment of generating a third image by extracting a crop region with respect to a crop region from a second image.

As shown in FIG. 4C, the image generator 180 may determine a crop region 415 for a second image 411 based on the horizontal angle θ_{H} of view determined by the embodiment of FIG. 4A and the vertical angle θ_{V} of view determined by the embodiment of FIG. 4B and may extract a crop image relative to the determined crop region 415.

In this case, the image generator 180 may generate a third image 421 based on the crop image. Herein, the image generator 180 may generate the third image 421 by adding a door-open warning image 425 to the crop image.

Meanwhile, the image generator 180 may determine partial regions of a first image and a second image obtained by an image obtaining device 170 of FIG. 2 as crop regions, respectively, and may extract a crop image with respect to each of the determined crop regions. Herein, the crop region of the first image may be defined as a “first crop region”. An image extracted relative to the first crop region may be defined as a “first crop image”. The crop region of the second image may be defined as a “second crop region”. An image extracted relative to the second crop region may be defined as a “second crop image”.

In this case, the image generator 180 may synthesize the first crop image with respect to the second crop image and may generate a third image based on the synthesized image.

Herein, the image generator 180 may calculate a horizontal angle of view of the first crop region (hereinafter referred to as “first horizontal angle of view”) based on a horizontal angle of view of the first camera. Further, the image generator 180 may calculate a horizontal angle of view of the second crop region (hereinafter referred to as “second horizontal angle of view”) based on a horizontal angle of view of the second camera.

Further, the image generator 180 may calculate a vertical angle of view of the first crop region (hereinafter referred to as “first vertical angle of view”) based on a vertical angle of view of the first camera, a vertical angle of view of the second camera, the first horizontal angle of view, and a resolution of the display screen. Further, the image generator 180 may calculate a vertical angle of view of the second crop region (hereinafter referred to as “second vertical angle of view”) based on a vertical angle of view of the first camera, a vertical angle of view of the second camera, the second horizontal angle of view, and a resolution of the display screen.

In this case, the image generator 180 may calculate a vertical angle of view of each of the first crop region and the second crop region based on a narrower angle of view between the first vertical angle of view and the second vertical angle of view.

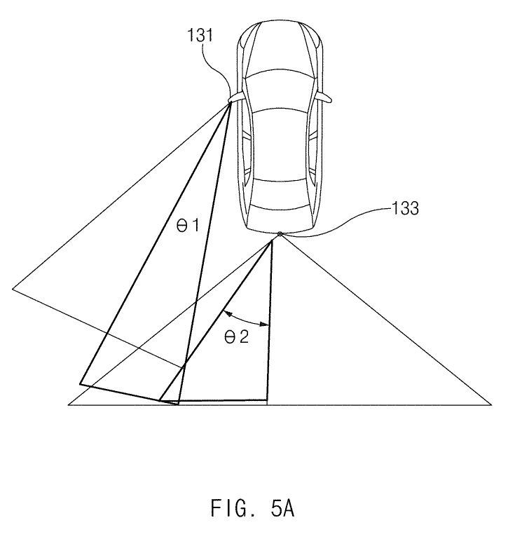

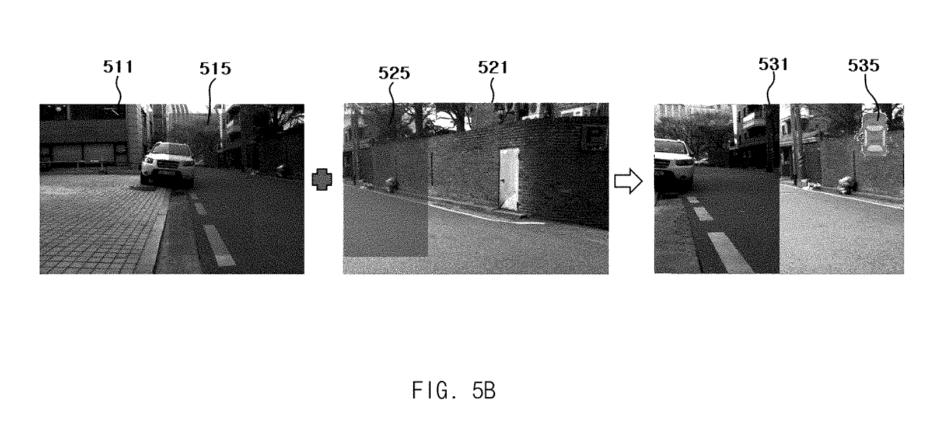

A description will be given of an example of determining the first crop region and the second crop region and generating the third image based on the determined crop region with reference to FIGS. 5A and 5B.

FIGS. 5A and 5B are drawings illustrating additional operation of the apparatus for controlling a display in a vehicle according to embodiments of the present disclosure. Here, a first camera is an outside-view monitoring camera 131 and as a second camera is a rear view image 133.

First of all, FIG. 5A illustrates an embodiment of determining a horizontal angle of view of each of a first crop region and a second crop region.

As shown in FIG. 5A, when a horizontal angle of view of the first camera is M, an image generator 180 Of FIG. 2 may calculate a first horizontal angle θ1 of view in a range of 0<θ1<M. As an example, if M is an angle of 30 degrees, the image generator 180 may calculate the first horizontal angle θ1 of view in a range of 0 degree<θ1<30 degrees. In this case, the first horizontal angle θ1 of view may be randomly determined in the range of 0<θ1<M.

Further, the image generator 180 may calculate a first vertical angle of view based on a vertical angle of view of the first camera, a vertical angle of view of the second camera, a first horizontal angle of view, and a resolution of a display screen. Herein, the image generator 180 may calculate the first vertical angle of view in the same manner as demonstrated in FIG. 4B.

Thus, the image generator 180 may determine a first crop region based on the first horizontal angle θ1 of view and the first vertical angle of view and may extract a first crop image with respect to the determined first crop region.

Further, when a horizontal angle of view of the second camera is N1, the image generator 180 may calculate a second horizontal angle θ2 of view in a range of 0<θ1<N1/2. For example, when M is angle of 70 degrees, the image generator 180 may calculate the second horizontal angle θ2 of view in a range of 0 degree<θ2<70 degrees. In this case, the second horizontal angle θ2 of view may be randomly determined in the range of θ<θ1<N1/2.

Further, the image generator 180 may calculate a second vertical angle of view based on a vertical angle of view of the first camera, a vertical angle of view of the second camera, a second horizontal angle of view, and resolution of the display. Herein, the image generator 180 may calculate the second vertical angle of view in the same manner as demonstrated in FIG. 4B.

Thus, the image generator 180 may determine a second crop region based on the second horizontal angle θ2 of view and the second vertical angle of view and may extract a second crop image with respect to the determined second crop region.

Herein, if the first vertical angle of view and the second vertical angle of view differ from each other, the image generator 180 may determine which of the first vertical angle of view and the second vertical angle of view is a narrower angle of view, and the narrower angle of view is used as a vertical angle of view for the first crop region and the second crop region. For example, if the first vertical angle of view is narrower than the second vertical angle of view, the image generator 180 may correct the second vertical angle of view to the first vertical angle of view and may determine a second crop region based on the second horizontal angle θ2 of view and the corrected second vertical angle of view (i.e., the first vertical angle of view).

FIG. 5B illustrates an embodiment of generating a third image based on a first crop image and a second crop image.

As shown in FIG. 5B, the image generator 180 may crop an image of a first crop region 525 determined for a first image 521 to generate a first crop image and may crop an image of a second crop region 515 determined for a second image 511 to generate a second crop image, based on the horizontal angle of view and the vertical angle of view determined by the embodiment of FIG. 5A.

In this case, the image generator 180 may synthesize the first crop image with respect to the second crop image and may generate a third image 531 based on the synthesized image. Herein, the image generator 180 may add a door-open warning image 535 to the synthesized image to generate the third image 531.

When a door is opened, an output controller 190 of FIG. 2 may change a first image display on a display to a third image generated by the image generator 180 and may display the changed third image on a display screen.

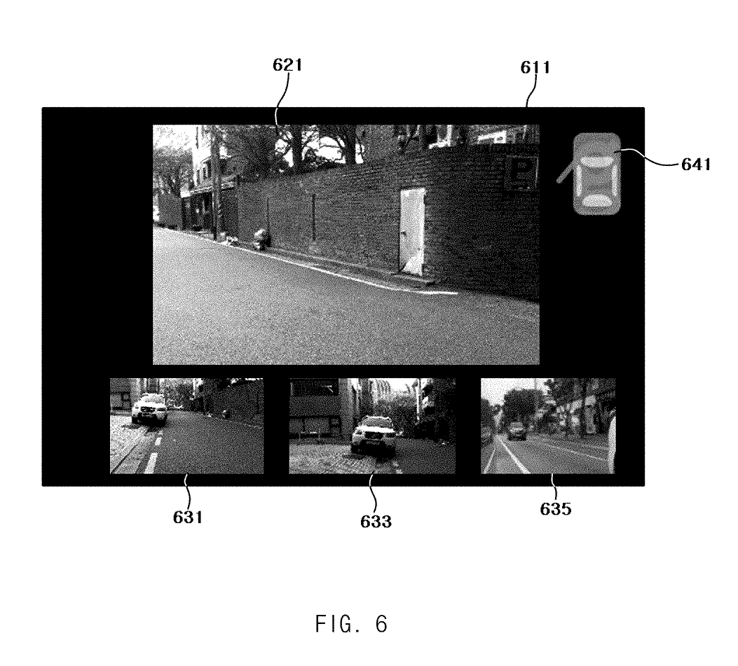

Meanwhile, if a plurality of second images are input by an image obtaining device 170 of FIG. 2, the output controller 190 may configure a third image selection screen for the input second images and may display the configured third image selection screen on a display screen. In this case, if one image is selected on the third image selection screen, the output controller 190 may transmit information about the selected second image to the image generator 180. A description will be given of an embodiment for the third image selection screen with reference to FIG. 6.

FIG. 6 is a drawing illustrating additional operation of an apparatus for controlling a display in a vehicle according to a narrower angle of view of the present disclosure. Here, a first camera is an outside vide monitoring camera 131 and as a second camera includes a rear view camera 133, a peripheral monitoring camera 135, and an inside-view monitoring camera 137.

As shown in FIG. 6, if a door-open state is detected while a first image is displayed on a display screen, an image obtaining device 170 of FIG. 2 may control all of a plurality of second cameras to be turned on and may obtain second images captured by the plurality of second cameras.

In this case, an output controller 190 of FIG. 2 may configure a third image selection screen 611 using the plurality of second images.

As shown in FIG. 6, the third image selection screen 611 may include a first image 621 previously displayed on a display. Further, the third image selection screen 611 may include a selection region. The selection region may display second images which become candidates to generate a third image, for example, an image 631 of the rear view camera 133, an image 633 of the inside-view monitoring camera 137, and an image 635 of the peripheral monitoring camera 135.

Thus, a user may select one image for generating the third image among the plurality of second images displayed on the selection region.

Further, the third image selection region 611 may include a door-open warning image 641 on its one region.

An image generator 180 of FIG. 2 may generate the third image based on the second image selected on the image generator 180. In this case, the output controller 190 may display the third image generated by the image generator 180 on a display screen.

As described above, the image generator 180 may generate the third image with respect to an image for a rear zone and a rear side zone in a direction where a door is opened. In this case, the output controller 190 may display the third image on a display of a direction where a door is opened among displays in the vehicle 10. In this case, the output controller 190 may continue displaying an image of the first camera on a display of a direction where a door is not opened.

Meanwhile, if at least one of a left door and a right door is opened, the image generator 180 may generate the third image with respect to an image for a rear zone and a rear side zone of a left and right direction irrespective of a direction where a door is opened. In this case, the output controller 190 may display the third image on each of left and right displays.

The display control apparatus 100 according to an embodiment of the present disclosure, which perform the above-mentioned operation, may be implemented in the form of an independent hardware device including a memory and a processor for processing each operation or may be driven in the form of being included in another hardware device such as a microprocessor or a universal computer system.

A description will be given in detail of an operation of the display control apparatus 100 according to an embodiment of the present disclosure, including the above-mentioned configuration.

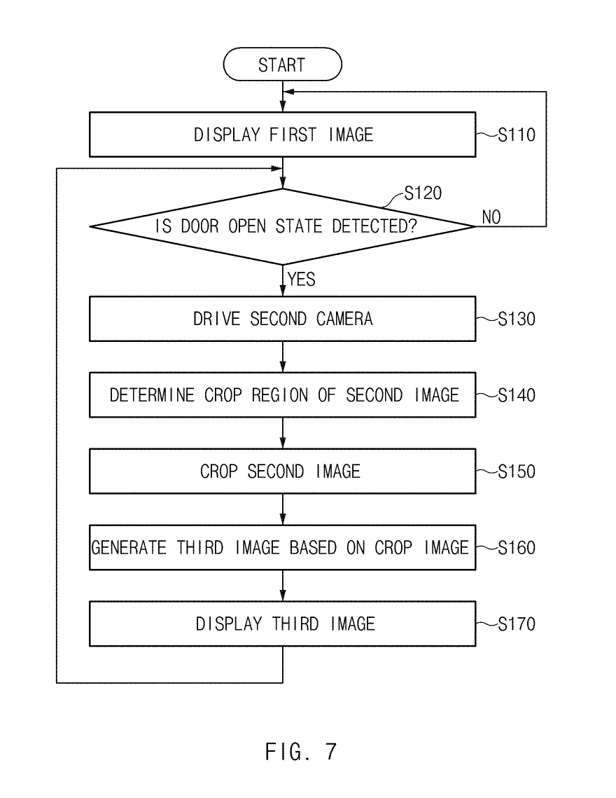

FIGS. 7 to 9 are flowcharts illustrating an operation of a method for controlling a display in a vehicle according to a narrower angle of view of the present disclosure.

Firstly, FIG. 7 illustrates an operation of a method for controlling a display in a vehicle according to embodiments of the present disclosure.

As shown in FIG. 7, in operation S110, a display control apparatus 100 of FIG. 1 may display a first image of a first camera on a display screen. If a door-open state of a vehicle 10 of FIG. 1 is detected in operation S120, in operation S130, the display control apparatus 100 may drive a second camera. Herein, the second camera may be a rear view camera 133 of FIG. 3A. However, embodiments are not limited thereto. For example, the second camera may be a peripheral monitoring camera 135 or an inside-view monitoring camera 137 of FIG. 3A.

In operation S140, the display control apparatus 100 may determine a crop region for a second image captured by the second camera. In this case, the display control apparatus 100 may determine a horizontal angle of view and a vertical angle of view of the crop region and may determine the crop region based on the determined horizontal angle of view and the determined vertical angle of view. The operation of determining the crop region may be performed as demonstrated in FIGS. 4A to 4C.

If the crop region for the second image is determined in operation S140, in operation S150, the display control apparatus 100 may crop an image of the crop region from the second image. In operation S160, the display control apparatus 100 may generate a third image based on the crop image in operation S150. In this case, the display control apparatus 100 may add a door-open warning image to the crop image to generate the third image.

In operation S170, the display control apparatus 100 may display the third image generated in operation S160 on a screen of a display. Herein, the display may be a display of a door-open direction in the vehicle 10 and may be a bidirectional display.

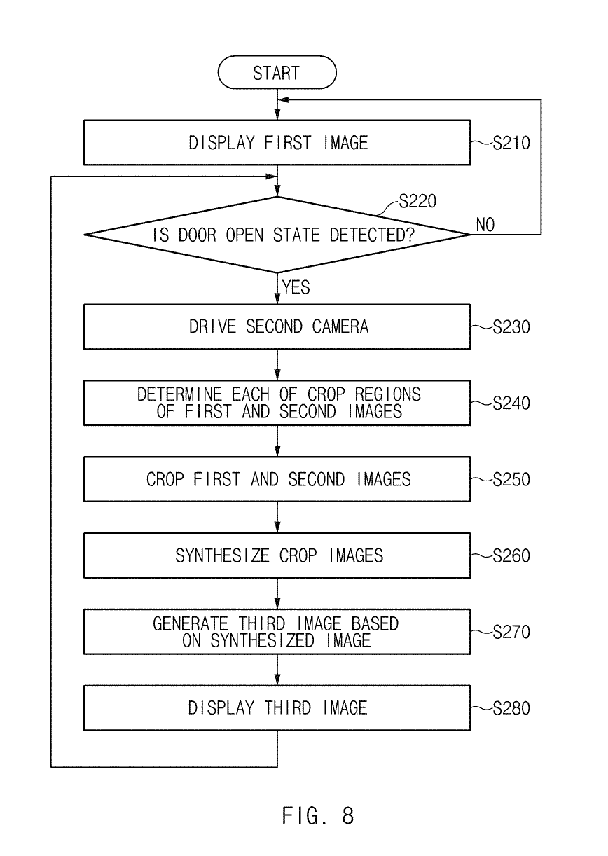

Next, FIG. 8 illustrates additional operation of a method for controlling a display in a vehicle according to embodiments of the present disclosure.

As shown in FIG. 8, in operation S210, a display control apparatus 100 of FIG. 1 may display a first image of a first camera on a display screen. In this case, if a door-open state of a vehicle 10 of FIG. 1 is detected in operation S220, in operation S230, the display control apparatus 100 may drive a second camera. Herein, the second camera may be a rear view camera 133 of FIG. 3A. However, embodiments are not limited thereto. According to an embodiment, the second camera may be a peripheral monitoring camera 135 or an inside-view monitoring camera 137 of FIG. 3A.

In operation S240, the display control apparatus 100 may determine each of crop regions for the first image and a second image respectively captured by the first camera and the second camera. Herein, the display control apparatus 100 may determine a horizontal angle of view and a vertical angle of view of each of the crop regions and may determine each of the crop regions based on the determined horizontal angle of view and the determined vertical angle of view. The operation of determining the crop regions for the first image and the second image may refer to an embodiment of FIGS. 5A and 5B.

If each of the crop regions for the first image and the second image is determined in operation S240, in operation S250, the display control apparatus 100 may crop an image of each of the crop regions from the first image and the second image. In operations S260 and S270, the display control apparatus 100 may synthesize the crop images in operation S250 and may generate a third image based on the synthesized image. In this case, the display control apparatus 100 may add a door-open warning image to the synthesized image in operation S260 to generate the third image.

In operation S280, the display control apparatus 100 may display the third image generated in operation S270 on a screen of a display. Herein, the display may be a display of a door-open direction in the vehicle 10 and may be a bidirectional display.

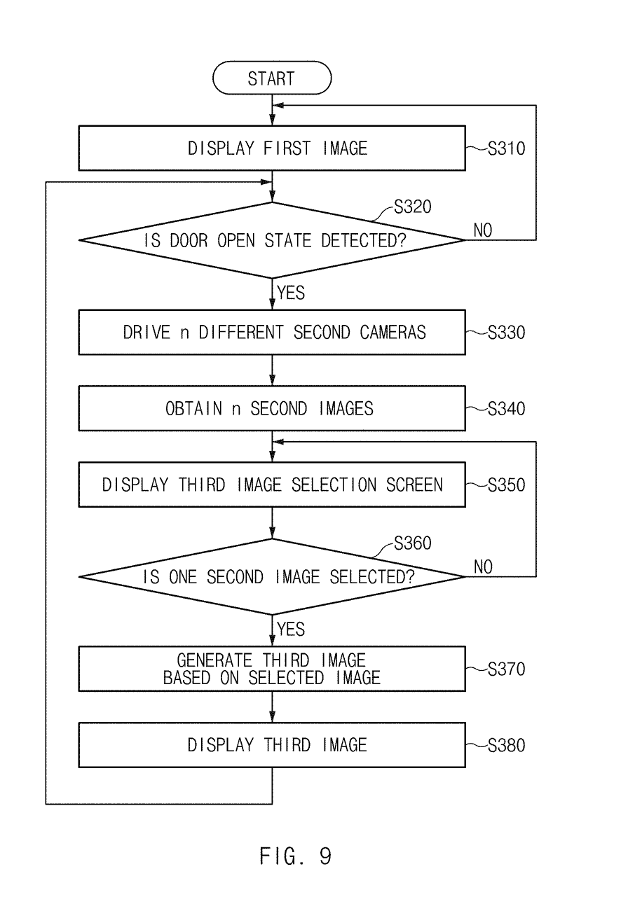

Next, FIG. 9 illustrates an operation of a method for controlling a display in a vehicle according to embodiments of the present disclosure.

As shown in FIG. 9, in operation S310, a display control apparatus 100 of FIG. 1 may display a first image of a first camera on a display screen. If a door-open state of a vehicle 10 of FIG. 1 is detected in operation S320, in operation S330, the display control apparatus 100 may drive a plurality of different second cameras. Herein, the n different second cameras may include a rear view camera 133, a peripheral monitoring camera 135, and/or an inside-view monitoring camera 137 of FIG. 3A.

In operation S340, the display control apparatus 100 may obtain second images captured by the n different second cameras. In operation S350, the display control apparatus 100 may configure a third image selection screen based on the obtained n second images and may display the configured third image selection screen on a display screen. For example, the third image selection screen may be a screen for selecting an image used to generate a third image among an image of the rear view camera 133, an image of the peripheral monitoring camera 135, and/or an image of the inside-view monitoring camera 137. An embodiment for the third image selection screen may refer to FIG. 6.

Thus, a driver may select one of the n second images from the third image selection screen displayed on the display screen. In this case, if one of the n second images displayed on the third image selection screen is selected in operation S360, in operation S370, the display control apparatus 100 may generate a third image based on the image selected in operation S360. In this case, the display control apparatus 100 may add a door-open warning image to the image selected on the third image selection screen to generate the third image. Further, the display control apparatus 100 may crop a partial region of the image selected on the third image selection screen and may add a door-open warning image to the crop image to generate the third image.

In operation S380, the display control apparatus 100 may display the third image generated in operation S370 on a screen of a display. Herein, the display may be a display of a door-open direction in the vehicle 10 and may be a bidirectional display.

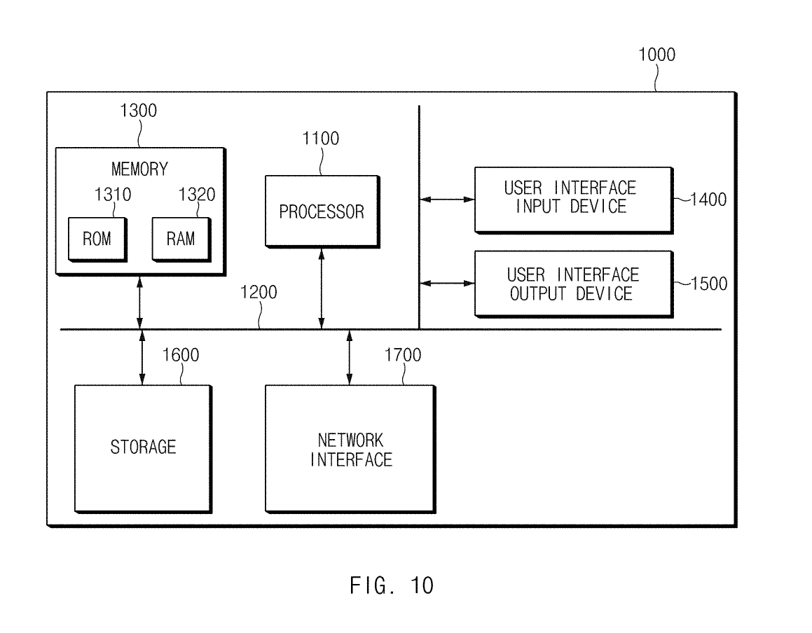

FIG. 10 is a block diagram illustrating a configuration of a computing system in which a method according to embodiments of the present disclosure is executed.

As shown in FIG. 10, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only memory (ROM) and a random access memory (RAM).

Thus, the operations of the methods or algorithms described in connection with the embodiments disclosed in the specification may be directly implemented with a hardware module, a software module, or combinations thereof, executed by the processor 1100. The software module may reside on a storage medium (e.g., the memory 1300 and/or the storage 1600) such as a RAM, a flash memory, a ROM, an erasable and programmable ROM (EPROM), an electrically EPROM (EEPROM), a register, a hard disc, a removable disc, or a compact disc-ROM (CD-ROM). An exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside in a user terminal. Alternatively, the processor and storage medium may reside as a separate component of the user terminal.

According to embodiments of the present disclosure, the display control apparatus may display on a display screen views of a rear and a rear side in a door-open state by generating a third image based on images of a rear zone and a rear side zone of a rear view camera, a peripheral monitoring camera, and/or an inside-view monitoring camera when detecting the door-open state of a vehicle, thus preventing a line of sight of external vehicle cameras from being obstructed.

While the present disclosure has been described with reference to exemplary embodiments, it will be apparent to those skilled in the art that various changes and modifications may be made without departing from the spirit and scope of the present disclosure. Therefore, exemplary embodiments of the present disclosure are not limiting, but illustrative, and the spirit and scope of the present disclosure is not limited thereto. The spirit and scope and the present disclosure should be interpreted by the following claims, it should be interpreted that all technical ideas which are equivalent to the present disclosure are included in the spirit and scope of the present disclosure.

What is claimed is:

1. An apparatus for controlling a display in a vehicle, the apparatus comprising:
a first camera mounted on a region of a door of the vehicle and configured to capture a first image of a side zone and a rear side zone of the vehicle;
a second camera mounted on a region of a rear end of the vehicle and configured to capture a second image of a rear zone and the rear side zone of the vehicle;
an image generator configured to generate a third image using the second image; and
an output controller configured to display the first image on a display screen when the vehicle is driven and to display the third image on the display screen when the door of the vehicle is opened.

2. The apparatus of claim 1, wherein the image generator is further configured to:
determine a partial region of the second image as a crop region;
extract a crop image with respect to the crop region; and
generate the third image using the extracted crop image

3. The apparatus of claim 2, wherein the image generator is further configured to:
calculate a horizontal angle of view of the crop region based on a horizontal angle of view of the first camera and a horizontal angle of view of the second camera; and
calculate a vertical angle of view of the crop region based on a vertical angle of view of the first camera, a vertical angle of view of the second camera, the calculated horizontal angle of view of the crop region, and a resolution of the display screen.

4. The apparatus of claim 2, wherein the image generator is further configured to:
generate the third image by adding a door-open warning image to the crop image.

5. The apparatus of claim 1, wherein the image generator is further configured to:
generate the third image by synthesizing the first image with respect to the second image.

6. The apparatus of claim 5, wherein the image generator is further configured to:
determine a partial region of the first image as a first crop region and determine a partial region of the second image as a second crop region;
extract a first crop image with respect to the first crop region; and
extract a second crop image with respect to the second crop region.

7. The apparatus of claim 6, wherein the image generator is further configured to:
calculate a horizontal angle of view of the first crop region based on a horizontal angle of view of the first camera; and
calculate a vertical angle of view of the first crop region based on a vertical angle of view of the first camera, a vertical angle of view of the second camera, the calculated horizontal angle of view of the first crop region, and a resolution of the display screen.

8. The apparatus of claim 6, wherein the image generator is further configured to:
calculate a horizontal angle of view of the second crop region based on a horizontal angle of view of the second camera; and
calculate a vertical angle of view of the second crop region based on a vertical angle of view of the first camera, a vertical angle of view of the second camera, the calculated horizontal angle of view of the second crop region, and a resolution of the display screen.

9. The apparatus of claim 6, wherein the image generator is further configured to:
determine the first crop region and the second crop region based on which of a vertical angle of view of the first crop region and a vertical angle of view of the second crop region is a narrower angle of view, when the vertical angle of view of the first crop region and the vertical angle of view of the second crop region differ from each other.

10. The apparatus of claim 6, wherein the image generator is further configured to:
generate a synthesis image by synthesizing the first crop image with respect to the second crop image; and
generate the third image based on the generated synthesis image.

11. The apparatus of claim 10, wherein the image generator is configured to:
generate the third image by adding a door-open warning image to the synthesis image.

12. The apparatus of claim 1, wherein the second camera includes one or more of: a rear view camera, a camera of a peripheral monitoring system, and a camera of an inside-view monitoring system.

13. The apparatus of claim 1, wherein the second camera includes a plurality of different cameras.

14. The apparatus of claim 13, wherein the output controller is further configured to:
generate a third image selection screen including a plurality of images obtained from the plurality of different cameras when the door is opened; and
display the third image selection screen on the display screen.

15. The apparatus of claim 14, wherein the third image selection screen includes a door-open warning image on a region of the third image selection screen.

16. The apparatus of claim 14, wherein, when one of the plurality of images displayed on the third image selection screen is selected, the image generator is further configured to:
generate the third image based on the selected image.

17. The apparatus of claim 13, wherein the second camera includes at least two or more of: a rear view camera, a camera of a peripheral monitoring system, and a camera of an inside-view monitoring system.

18. A method for controlling a display in a vehicle, the method comprising:
capturing a first image of a side zone and a rear side zone of the vehicle using a first camera mounted on a region of a door of the vehicle;
capturing a second image of a rear zone and the rear side zone of the vehicle using a second camera mounted on a region of a rear end of the vehicle;
generating a third image using the second image;
displaying the first image on a display screen when the vehicle is driven; and
displaying the third image on the display screen when the door of the vehicle is opened.

19. The method of claim 18, wherein the generating of the third image comprises:
determining a partial region of the second image as a crop region;
extracting a crop image with respect to the crop region; and
generating the third image using the extracted crop image.

20. The method of claim 18, wherein the generating of the third image comprises:
determining a partial region of the first image as a first crop region;
extracting a first crop image with respect to the first crop region;
determining a partial region of the second image as a second crop region;
extracting a second crop image with respect to the second crop region;
generating a synthesis image by synthesizing the first crop image with respect to the second crop image; and
generating the third image based on the generated synthesis image.

21. The method of claim 18, further comprising:
generating a third image selection screen including a plurality of images obtained from a plurality of different cameras configured to capture a rear zone and the rear side zone of the vehicle when the door is opened; and
displaying the third image selection screen on the display screen.

22. The method of claim 21, wherein, when one of the plurality of images displayed on the third image selection screen is selected, the generating of the third image comprises:
generating the third image based on the selected image.
